(19) United States
(12) Patent Application Publication
(10) Pub. No.: US 2005/0060576 A1
(43) Pub. Date: Mar. 17, 2005

(54) Method, apparatus and system for detection of and reaction to rogue access points

(76) Inventors: Gregory C. Kime, Portland, OR (US); Satyendra Yadav, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/663,495

(22) Filed: Sep. 15, 2003

(51) Int. Cl. H04L 9/00; G06F 15/173

(52) U.S. Cl. 713/201; 709/225

(57) ABSTRACT

A method, apparatus and system for detection of and reaction to rogue access points is generally presented. In this regard, a security agent is introduced to compare at least a subset of information received from a wired network device with information previously stored to determine if a rogue access point is present.

### FIELD OF THE INVENTION

Embodiments of the present invention generally relate to the field of network security, and, more particularly to a method, apparatus and system for detection of and reaction to rogue access points.

### BACKGROUND

A security concern for computing network administrators is the presence of rogue access points. Whether intentional or not, a rogue access point may allow unauthorized clients to have access to network resources. A rogue access point may also hijack authorized clients by luring them to connect to the rogue access point.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example network environment suitable for implementing the security agent, in accordance with one example embodiment of the invention,

FIG. 2 is a block diagram of an example security agent architecture, in accordance with one example embodiment of the invention; and

FIG. 3 is a flow chart of an example method for detecting and reacting to a rogue access point, in accordance with one example embodiment of the invention.

### DETAILED DESCRIPTION

Embodiments of the present invention are generally directed to a method, apparatus and system for detection of and reaction to rogue access points. In this regard, in accordance with but one example implementation of the broader teachings of the present invention, a security agent is introduced. In accordance with but one example embodiment, the security agent employs an innovative method to recognize the presence of a rogue access point, and initiate actions against it. According to one example method, the security agent detects a rogue access point through radio frequency signals transmitted by the rogue access point. According to an alternate example method, the security agent detects a rogue access point through network traffic generated by the rogue access point.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

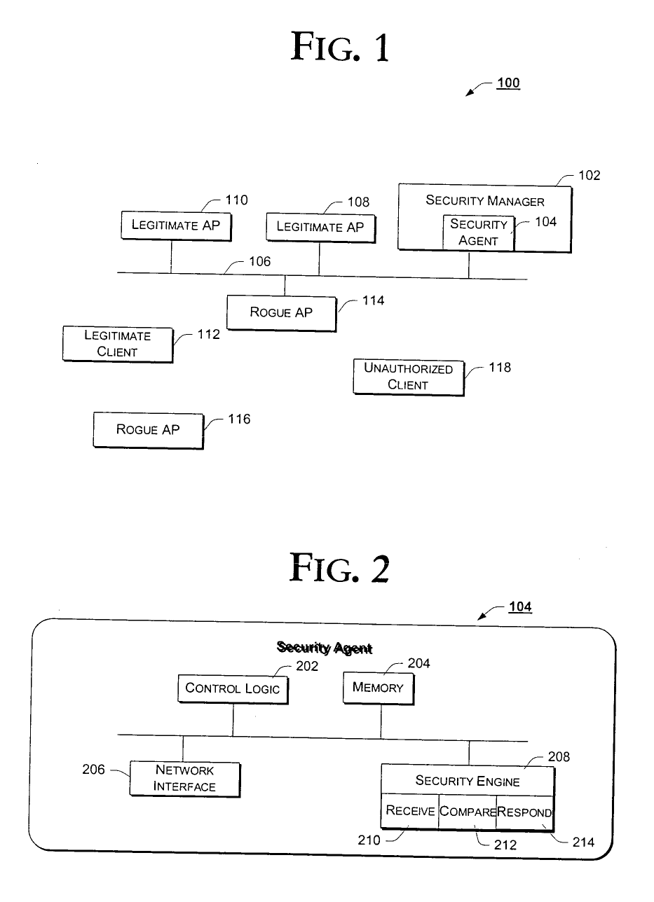

FIG. 1 is a block diagram of an example network environment suitable for implementing the security agent, in accordance with one example embodiment of the invention. In accordance with an example implementation, network environment 100 is intended to represent any of a number of network types including, but not limited to: wired, wireless, or any combination of wired and wireless data and/or communication networks employing any of a number of wired and/or wireless networking protocols. In accordance with the illustrated example embodiment, network environment 100 may include one or more of a security manager 102, security agent 104, network backbone 106, legitimate access points (AP) 108 and 110, legitimate client 112, rogue access points 114 and 116, and unauthorized client 118 coupled as shown in FIG. 1. Security agent 104, as described more fully hereinafter, may well be used in electronic appliances and network environments of greater or lesser complexity than that depicted in FIG. 1. Also, the innovative security attributes of security agent 104 as described more fully hereinafter may well be embodied in any combination of hardware and software.

Security agent 102 may represent any type of electronic appliance or device that hosts security agent 104. In one embodiment, security agent 102 may be a server, such as, for example, a domain host control protocol (DHCP) server. In an alternate embodiment, security agent 102 may be a wireless access point.

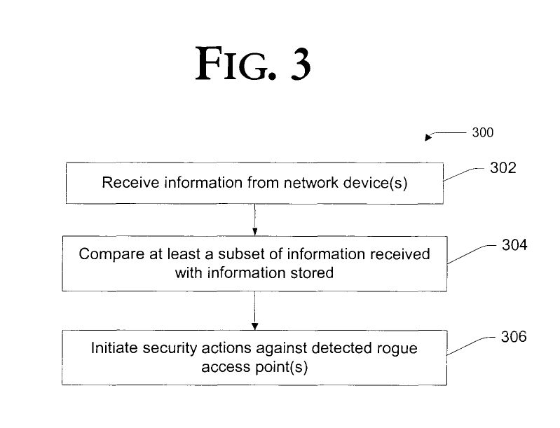

Security agent 104 may have an architecture as described in greater detail with reference to FIG. 2. Security agent 104 may also perform one or more methods of detecting and reacting to a rogue access point, such as the method described in greater detail with reference to FIG. 3.

Network backbone 106 may represent any medium and/or protocol to communicatively couple electronic devices. In one embodiment, network backbone 106 may represent an ethernet network, although the invention is not limited in this regard. In an alternate embodiment, network backbone 106 may represent an asynchronous transfer mode (ATM) network.

Legitimate access points 108 and 110 may represent any type of electronic appliance or device that an administrator has configured to interface between client devices and devices coupled with network backbone 106. In one embodiment, legitimate access points 108 and 110 may represent Institute of Electrical and Electronics Engineers, Inc. (IEEE) 802.11b compliant wireless access points. Legitimate access points 108 and 110 may have security provisions in place to allow legitimate clients, for example 112, to access network resources while preventing unauthorized clients, for example 118, from accessing network resources. Legitimate access points 108 and 110 may have the ability to notify an administrative device, for example security manager 102, of other access points, for example 114 and 116, that are transmitting radio frequency (RF) signals. AP's 108 and 110 may issue a “security report” that may contain information such as media access control (MAC) addresses, service set identification (SSID), RF band and channel used, and/or signal strength pertaining to transmissions detected. These security reports may be used by security agent 104, as described hereinafter, to detect and react to rogue access points.

Legitimate client 112 may represent a laptop or any other computing device that is authorized to access network resources. Legitimate client 112 may attempt to connect to one or more of access points 108, 110, 114, and 116, based on, perhaps, received signal strength. Legitimate client 112 may or may not be able to determine that access points 114 and 116 are rogue access points. In one embodiment, legitimate client 112 may broadcast information received from access points that may be received and included in a security report by legitimate access points 114 and 116.

Rogue access points 114 and 116 may represent any type of electronic appliance or device that has the ability to, but that an administrator has not configured to, interface with client devices. Rogue access point 114 may be authorized to access network resources through network backbone 106 as a client, however rogue access point 114 may have been configured by someone other than an administrator with software and/or hardware to allow rogue access point 114 to function as a wireless access point. Rogue access point 114 may not have the security provisions as legitimate access points 108 and 110 to distinguish between legitimate client 112 and unauthorized client 118, and may thereby allow the latter to obtain an internet protocol (WP) address and access network resources that it shouldn't. Rogue access point 116 may not have access to network backbone 106, but it may have the ability to “hijack” legitimate client 112, by luring 112 to connect to 116. Rogue access point 116 may then be able to access information from or maliciously act on legitimate client 112.

Unauthorized client 118 may represent a laptop or any other computing device that is not authorized to access network resources. While unauthorized client 118 may not be able to gain access to network backbone 106 through legitimate access points 108 or 110, because of security provisions, unauthorized client 118 may be able to gain access to network backbone 106 through rogue access point 114, because of the latter's lack of the security provisions.

FIG. 2 is a block diagram of an example security agent architecture, in accordance with one example embodiment of the invention. As shown, security agent 104 may include one or more of control logic 202, memory 204, network interface 206, and security engine 208 coupled as shown in FIG. 2. In accordance with one aspect of the present invention, to be developed more fully below, security agent 104 may include a security engine 208 comprising one or more of receive services 210, compare services 212, and/or respond services 214. It is to be appreciated that, although depicted as a number of disparate functional blocks, one or more of elements 202-214 may well be combined into one or more multi-functional blocks. Similarly, security engine 208 may well be practiced with fewer functional blocks, i.e., with only compare services 212, without deviating from the spirit and scope of the present invention. In this regard, security agent 104 in general, and security engine 208 in particular, are merely illustrative of one example implementation of one aspect of the present invention. As used herein, security agent 104 may well be embodied in hardware, software, firmware and/or any combination thereof.

As introduced above, security agent 104 may have the ability to detect and respond to rogue access points, for example, 114 and 116. In one embodiment, the functionality of security agent 104 may be performed by software within security manager 102 or even within a different device, for example legitimate access points 108 and 110.

As used herein control logic 202 provides the logical interface between security agent 104 and security manager 102. In this regard, control logic 202 may manage one or more aspects of security agent 104 to provide a communication interface from security manager 102 to network information resident thereon. According to one aspect of the present invention, though the claims are not so limited, control logic 202 may receive event indications such as, e.g., availability of a new security report. Upon receiving such an indication, control logic 202 may selectively invoke the resource(s) of security engine 208. As part of an example method for detecting and responding to a rogue access point, as explained in greater detail with reference to FIG. 3, control logic 202 may selectively invoke receive services 210 and compare services 212 that may receive and compare contents of a security report or other network traffic to determine if a rogue access point is present in the network environment. Control logic 202 also may selectively invoke respond services 214, as explained in greater detail with reference to FIG. 3, to initiate actions against a detected rogue access point. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In alternate implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store security reports or other network traffic received from other network devices, for example 108 and 110, and/or may store information entered by an administrator regarding authorized network devices and clients.

Network interface 206 provides a path through which security agent 104 can communicate with other network devices, for example 108 and 110, over network backbone 106 to, for example, receive security reports. Network interface 206 is intended to represent any of a wide variety of network interfaces and/or controllers known in the art.

As introduced above, security engine 208 may be selectively invoked by control logic 202 to receive security reports, to compare contents of the security reports to a list of authorized devices and clients, and to initiate actions against any detected rogue access points. In accordance with the illustrated example implementation of FIG. 2, security engine 208 is depicted comprising one or more of receive services 210, compare services 212 and respond services 214. Although depicted as a number of disparate elements, those skilled in the art will appreciate that one or more elements 210-214 of security engine 208 may well be combined without deviating from the scope and spirit of the present invention.

Receive services 210, as introduced above, may provide security agent 104 with the ability to receive security reports or other network traffic from network devices, possibly 108 and 110. In one example embodiment, receive services 210 may receive a security report from legitimate access points 108 and/or 110 containing information such as MAC addresses, SSID's, RF band and channel used, and/or signal strength pertaining to transmissions detected. In an alternate embodiment, receive services 210 may receive network traffic, such as network traffic transmitted by or through rogue access point 114.

As introduced above, compare services 212 may provide security agent 104 with the ability to compare contents received by receive services 210 to lists of authorized devices. In one example embodiment, compare services 212 may compare information received in security reports with information previously stored of authorized access points to determine if a rogue access point, 114 and/or 116, is transmitting in the area. In an alternate embodiment, compare services 212 may compare client information, such as IP and/or MAC addresses, from network traffic received with information previously stored of authorized clients to determine if an unauthorized client, 118, is accessing network resources, perhaps through a rogue access point, 114.

Respond services 214, as introduced above, may provide security agent 104 with the ability to initiate actions against any detected rogue access points. In one embodiment, respond services 214 may send an alert to an administrator with pertinent information. In an alternate embodiment, respond services 214 may initiate actions to terminate network access of unauthorized access points and/or clients by perhaps denying service to particular IP or MAC addresses.

FIG. 3 is a flow chart of an example method for detecting and reacting to a rogue access point, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention. The method begins with receive services 210 receiving (302) information from network device(s). In one example embodiment, receive services 210 may receive a security report from legitimate access points 108 and/or 110 containing information such as MAC addresses, SSID's, RF band and channel used, and/or signal strength pertaining to transmissions detected. In an alternate embodiment, receive services 210 may receive network traffic, such as network traffic transmitted by or through rogue access point 114.

Next, compare services 212 compares (304) at least a subset of the information received with information stored. In one example embodiment, compare services 212 may compare information received in security reports with information previously stored of authorized access points to determine if a rogue access point, 114 and/or 116, is transmitting in the area. In an alternate embodiment, compare services 212 may compare client information, such as IP and/or MAC addresses, from network traffic received with information previously stored of authorized clients to determine if an unauthorized client, 118, is accessing network resources, perhaps through a rogue access point, 114.

Then, respond services 214 will initiate (306) security actions against detected rogue access point(s). In one embodiment, respond services 214 may send an alert to an administrator with pertinent information. In an alternate embodiment, respond services 214 may initiate actions to terminate network access of unauthorized access points and/or clients by perhaps denying service to particular IP or MAC addresses.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
comparing at least a subset of information received from a wired network device with information previously stored to determine if a rogue access point is present.

2. The method of claim 1, wherein comparing at least a subset of information received from a wired network device with information previously stored to determine if a rogue access point is present comprises:
comparing at least a subset of information received in a security report from a legitimate access point with information previously stored to determine if a rogue access point is present.

3. The method of claim 1, wherein comparing at least a subset of information received from a wired network device with information previously stored to determine if a rogue access point is present comprises:
comparing at least a subset of client network traffic received with information previously stored to determine if a rogue access point is present.

4. The method of claim 1, further comprising:
initiating countermeasures against rogue access points determined to be present.

5. The method of claim 4, wherein initiating countermeasures against rogue access points determined to be present comprises:
denying of service to rogue access points and/or clients connected to rogue access points determined to be present.

6. An electronic appliance, comprising:
a network interface to receive information; and
a security engine coupled with the network interface, the security engine to compare at least a subset of information received from a wired network device with information previously stored to determine if a rogue access point is present.

7. The electronic appliance of claim 6, wherein the security engine to compare at least a subset of information received from a wired network device with information previously stored to determine if a rogue access point is present comprises:
the security engine to compare at least a subset of information received in a security report from a legitimate access point with information previously stored to determine if a rogue access point is present.

8. The electronic appliance of claim 6, wherein the security engine to compare at least a subset of information received from a wired network device with information previously stored to determine if a rogue access point is present comprises:
the security engine to compare at least a subset of client network traffic received with information previously stored to determine if a rogue access point is present.

9. The electronic appliance of claim 6, further comprising the security engine to initiate countermeasures against rogue access points determined to be present.

10. The electronic appliance of claim 9, wherein the security engine to initiate countermeasures against rogue access points determined to be present comprises:
the security engine to deny service to rogue access points and/or clients connected to rogue access points determined to be present.

11. A storage medium comprising content which, when executed by an accessing machine, causes the machine to implement a security agent in the accessing machine, the security agent to compare at least a subset of information received from a wired network device with information previously stored to determine if a rogue access point is present.

12. The storage medium of claim 11, wherein the content to compare at least a subset of information received from a wired network device with information previously stored to determine if a rogue access point is present comprises content which, when executed by the accessing machine, causes the accessing machine to compare at least a subset of information received in a security report from a legitimate access point with information previously stored to determine if a rogue access point is present.

13. The storage medium of claim 11, wherein the content to compare at least a subset of information received from a wired network device with information previously stored to determine if a rogue access point is present comprises content which, when executed by the accessing machine, causes the accessing machine to compare at least a subset of client network traffic received with information previously stored to determine if a rogue access point is present.

14. The storage medium of claim 11, further comprising content which, when executed by the accessing machine, causes the accessing machine to initiate countermeasures against rogue access points determined to be present.

15. The storage medium of claim 14, wherein the content to initiate countermeasures against rogue access points determined to be present comprises content which, when executed by the accessing machine, causes the accessing machine to deny service to rogue access points and/or clients connected to rogue access points determined to be present.

16. An apparatus comprising:
a wireless access point configured to generate a security report containing at least a subset of information received from other access points.

17. The apparatus of claim 16, wherein the wireless access point complies with the Institute of Electrical and Electronics Engineers, Inc. (IEEE) 802.11 specification.

18. The apparatus of claim 16, further comprising the wireless access point to transmit the security report to a networked device.

19. The apparatus of claim 16, wherein the security report contains one or more of a media access control (MAC) address, a service set identification (SSID), a radio frequency (RF) band, a RF channel, and/or a signal strength.
